(19) United States
(12) Patent Application Publication
(10) Pub. No.: US 2018/0229247 A1
(43) Pub. Date: Aug. 16, 2018

(54) PULSED SPRAY NOZZLE ARRANGEMENTS

(71) Applicant: LEAFGREEN LIMITED, STOURBRIDGE, WEST MIDLANDS (GB)

(72) Inventor: KEITH LAIDLER, WEST MIDLANDS (GB)

(21) Appl. No.: 15/751,998

(22) PCT Filed: Aug. 11, 2016
(86) PCT No.: PCT/GB2016/000149

§ 371 Date: Feb. 12, 2018

(30) Foreign Application Priority Data
Aug. 14, 2015 (GB) 1514468.6
May 11, 2016 (GB) 1608242.2

(51) Int. Cl. B05B 1/08; B05B 1/34; B05B 1/30

(52) U.S. Cl. CPC B05B 1/086; B05B 1/3013; B05B 1/3468

(57) ABSTRACT

A nozzle arrangement connected to a source of pressurized fluid mat produces a series of fast pulsed discharges of fluid in quick succession wherein the nozzle arrangement comprises a nozzle body with an inlet for the pressurized fluid into a chamber with a downstream wall with an outlet hole in said chamber wall wherein a prodder moves between a sealed and unsealed position in said outlet hole of the chamber wall and wherein a sprung plunger that is upstream of and connected to said prodder and has a annular seal that forms a seal between said plunger and the chamber creating a mobile chamber wall upstream of the downstream wall in said chamber, simultaneously moves between a downstream and an upstream position as the chamber fills with the fluid and then returns to a downstream position as the prodder returns from an unsealed position to a sealed position while the fluid is discharged.

The present invention relates to a nozzle arrangement for delivering fluid from a nozzle in a fast pulsed or none continuous way and to use the pulsing action to enhance the spray or foam being produced.

In a preferred application the pulsing action is used to pump air into the fluid as it is discharged. In another preferred arrangement, a pulsed nozzle arrangement is used with aerosol canisters to deliver a pulsed atomised spray or foam instead of a continuous spray. In another preferred arrangement, a pulsed nozzle arrangement is used with manually activated dispenser pumps actuated with an actuator or a trigger so that each stroke of the pump produces a number of pulsed discharges instead of a single discharge and these are in the form of an atomised spray or a foam. The pulsed nozzle arrangements can be either with or without air.

In several of the preferred applications the nozzle arrangement uses a conically tapered prodder tip insert in the final orifice forcing the fluid to exit the nozzle through a very narrow circumferential gap. The fluid enters into a chamber and then spins around the prodder in said chamber and then exits through a fine circumferential gap between the prodder tip and the outlet orifice. The prodder is able to slideably move within the outlet orifice and the movement is preferably but not exclusively restricted. The arrangement naturally produces a hollow cone but can be configured so that a substantially full cone spray or foam is produced. This spray configuration is dealt with more in the sister patent of this one that is being entered at the same time.

Nozzle arrangements such as actuators are used in water showers to reduce the volume of water used. Theses also pulse quickly at up to 40 pulses a second and the flow appears to be continuous like a machine gun firing bullets. Dispenser pumps that are activated with actuators or triggers also deliver a pulse of fluid with each stroke and the discharge corresponds to the volume delivered from the pump chamber. But even the fastest of these only delivers a pulse every 0.2 seconds plus and usually it is more.

It is well known that adding air to liquor as an atomized spray or foam greatly improves the quality of the spray and foam and the greater the ratio of air to liquor the higher the quality. Sprays have finer droplets, less fallout of the spray and more viscose liquors can be atomised. Similarly, foams have finer cells sizes and much more viscose liquors can be foamed producing a richer foam that lasts longer. The main problem is that it is difficult to generate air in small devices at low cost and without using more effort. Dispenser foamers sold in shops, mix air and liquor using a large pump chamber to generate the air and mixing it with liquor from a smaller pump chamber with a ratio of between 8 and 15-1 air to liquor. But the devices are bulky and cost around twice the price of a dispenser for liquor so the sales are severely restricted. Mixing air and liquor is commonly done in industry and compressors are usually used to provide the air. Air is also commonly added to liquor by using venturi holes shaped so that air is sucked into the liquor and these are generally very low cost but they aren't that effective.

What is needed is a new way of adding air to liquor that is simple, reliable, low cost, takes up a small amount of space, offers a range of air to liquor ratios, works with a range of different pressures and can be added to many applications. Some examples of where is would be beneficial include aerosols especially powered by compressed gas or air and particularly for viscose liquors, dispenser pumps actuated by an actuator or trigger handle and especially for sprays or foams, flexible tubes or pipes delivering fluids through a nozzle, water shower n the home, and many applications in industry.

Nozzle arrangements are used to facilitate the dispensing of various fluids from containers or vessels. For instance, nozzle arrangements are commonly fitted to pressurised fluid filled vessels or containers, such as a so called “aerosol canister”, to provide a means by which fluid stored in the vessel or container can be dispensed. A typical nozzle arrangement comprises an inlet through which fluid accesses the nozzle arrangement, an outlet through which the fluid is dispensed into the external environment, and an internal flow passageway through which fluid can flow from the inlet to the outlet. In addition, conventional nozzle arrangements comprise an actuator means, such as, for example, a manually operated aerosol canister. The operation of the actuator in the active phase causes fluid to flow from the container to which the arrangement is attached into the inlet of the arrangement, where it flows along the fluid flow passageway to the outlet.

Manually actuated pump type fluid dispensers are commonly used to provide a means by which fluids can be dispensed from a non-pressurised container. Typically, dispensers of this kind have a pump arrangement which is located above the container when in use. The pump includes a pump chamber connected with the container by means of an inlet having an inlet valve and with a dispensing outlet via an outlet valve. To actuate the dispenser, a user manually applies a force to an actuator or trigger to reduce the volume of the pump chamber and pressurise the fluid inside. Once the pressure in the chamber reaches a pre-determined value, the outlet valve opens and the fluid is expelled through the outlet. When the user removes the actuating force, the volume of the chamber increases and the pressure in the chamber falls. This closes the outlet valve and draws a further charge of fluid up into the chamber through the inlet. A range of fluids can be dispensed this way this way including pastes, gels, liquid foams and liquids. In certain applications, the fluid is dispensed in the form of an atomised spray, in which case the outlet will comprise an atomising nozzle. The actuator may be push button or cap, though in some applications the actuator arrangement includes a trigger that can be pulled by a user's fingers.

A large number of commercial products are presented to consumers in both an aerosol canister and in a manual pump type dispenser, including, for example, antiperspirant, de-odorant, perfumes, air fresheners, antiseptics, paints, insecticides, polish, hair care products, pharmaceuticals, shaving gels and foams, water and lubricants.

There are numerous types of manually activated pumps and triggers and aerosol canisters on the market and they are sold in enormous volumes especially through the major retailers such as supermarkets. Consequently, they are very cheap and there is little profit in them for the manufacturers. Many of these and other applications would benefit from an improved performance using air added to the fluid. The problem is how to do this at a low cost and make it reliable and user friendly.

We have solved this problem by using a nozzle arrangement that delivers fast pulses of fluid so the user hardly notices any difference from the continuous delivery. Aerosol canisters normally deliver a continuous discharge but the pulses are so fast that it appears to be a continuous discharge and the performance is largely unaffected by the pulses. With dispenser pumps actuated by an actuator or trigger, each discharge is pulsed so fast that there still appears to be one discharge and the delivery is as good as before. In showers or industrial or horticultural applications the same applies. Usually, these discharges are in the form of an atomised spray or a foam. The pulses can be slower where the requirement exists and we put no limitations on the frequency of the pulses.

In a preferred version, air is pumped into the fluid either inside the nozzle arrangement or just after the final orifice. The action of the pulsed element creating the pulses causes a movement of at least part of the pulsed element and this movement is used to cause air to be drawn inside the nozzle arrangement and then pumped out with each pulse.

According to a first aspect of the present invention there is provided A nozzle arrangement connected to a source of pressurized fluid that produces a series of fast pulsed discharges of fluid in quick succession wherein the nozzle arrangement comprises a nozzle body with an inlet for the pressurized fluid into a chamber with a downstream wall with an outlet hole in said chamber wall wherein a prodder moves between a sealed and unsealed position in said outlet hole of the chamber wall and wherein a sprung plunger that is upstream of and connected to said prodder and has a annular seal that forms a seal between said plunger and the chamber creating a mobile chamber wall upstream of the downstream wall in said chamber, simultaneously moves between a downstream and an upstream position as the chamber fills with the fluid and then returns to a downstream position as the prodder returns from an unsealed position to a sealed position while the fluid is discharged

According to a second aspect of the present invention there is provided a nozzle arrangement connected to a source of pressurized fluid that produces a pulsed discharge of fluid and simultaneously draws in a second none pressurized fluid into one or more pump chambers and discharges both fluids with each pulse wherein the second fluid is air or any gas or a liquor and gas.

According to a third aspect of the present invention there is provided a nozzle arrangement as in the preceding aspect wherein the two fluids are mixed either inside or outside of the nozzle.

According to a fourth aspect of the present invention there is provided a nozzle arrangement as in any of the preceding aspects wherein the nozzle arrangement is connected to the outlet of a pump dispenser actuated by an actuator or trigger handle or to the outlet of a pressurized container which may be an aerosol canister

According to an fifth aspect of the present invention there is provided a nozzle arrangement as in any of the preceding aspects that produces more than 5, 10, or 20 pulsed discharges of fluid every second.

According to a sixth aspect of the present invention there is provided a nozzle arrangement as in any of the preceding aspects wherein the discharge volume per pulse of one of the fluids is less than 10, 1, 0.5, 0.2, 0.1, 0.05, or 0.01 mls

According to a seventh aspect of the present invention there is provided a nozzle arrangement as in any of the preceding aspects wherein one of the two fluids is greater in volume than the other by a factor of 2, 5, or 10

According to an eighth aspect of the present invention there is provided a nozzle arrangement whereby the nozzle arrangement comprises a nozzle body with an inlet for a first fluid, an inlet for a second fluid and at least one outlet for fluid, and a pulsing element made of a resiliently deformable material, 2 or more annular valves that form chambers between the pulsing element and the nozzle body and a first spring element between the pulsing element and the nozzle body, plus a prodder that moves between a sealed and unsealed position on the outlet hole of the nozzle body as the pulsing element moves between a downstream and an upstream position.

According to a ninth aspect of the present invention there is provided a nozzle arrangement as in the preceding aspects wherein a nozzle arrangement that produces a pulsed discharge wherein the nozzle arrangement comprises a nozzle body with an inlet for a pressurized fluid into a chamber with a main plunger that has an annular valve that forms a pump chambers between the main plunger and the nozzle body and a spring element between the main plunger and the nozzle body, plus a prodder that moves between a sealed and unsealed position on the outlet hole of the nozzle body as the main plunger moves between a downstream and an upstream position.

According to a tenth aspect of the present invention there is provided a nozzle arrangement that produces a pulsed discharge wherein a prodder extends into the spray orifice to affect the spray and wherein the orifice or prodder or chamber wall or any combination of them are shaped so as to cause the fluid to rotate around part of the prodder to atomise the spray.

According to an eleventh aspect of the present invention there is provided a nozzle arrangement that produces a pulsed discharge wherein the prodder extends into the spray orifice and the pulsing of the prodder causes a component that the prodder strikes or that is a part of the prodder to vibrate creating a shock or sound wave that aids atomization of the spray.

According to a twelfth aspect of the present invention there is provided a nozzle arrangement that produces a pulsed discharge wherein an electrostatic charge is generated between the prodder or plunger and another component by shaping one or both parts so that they rub against each other during the pulses and they are both made of suitable materials to enhance that charge and wherein the fluid being discharged picks up that charge to generate a charged spray or foam.

According to a thirteenth aspect of the present invention there is provided a nozzle arrangement used to generate a pulsed spray or foam from an aerosol canister.

According to a fourteenth aspect of the present invention there is provided a nozzle arrangement used to generate a pulsed spray or foam from a pressurized fluid source including an aerosol canister where a second fluid or air is also drawn in and pumped out with each pulse.

According to a fifteenth aspect of the present invention there is provided a nozzle arrangement used to generate a pulsed spray or foam from a pump including one actuated with an actuator or trigger handle wherein there are at least 3 pulses per pump cycle.

According to a sixteenth first aspect of the present invention there is provided a nozzle arrangement used to generate a pulsed spray or foam from a pump including one actuated with an actuator or trigger handle wherein there are at least 3 pulses per pump cycle and wherein a second fluid or air is also drawn in and pumped out with each pulse.

According to a seventeenth aspect of the present invention there is provided a nozzle arrangement as in any of the previous aspects wherein the circumferential gap is less than 5, 20, 50, 300, 500 microns.

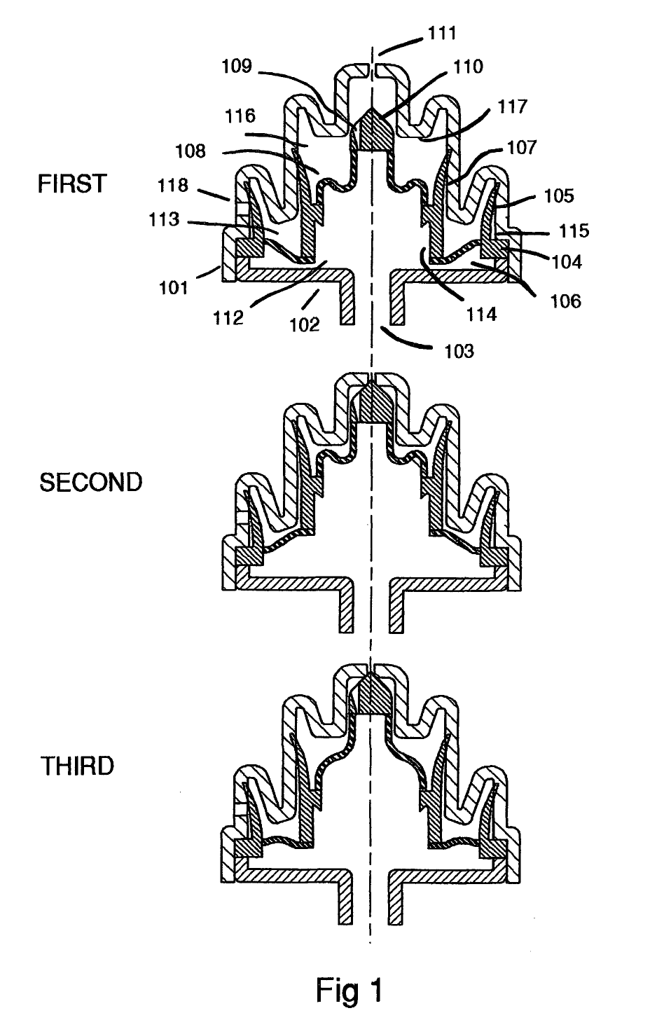

FIG. 1 is a cross-sectional view of a nozzle arrangement showing a preferred version where a second fluid is mixed with the first fluid inside the nozzle and then pumped out and 3 stages of the operation are shown.

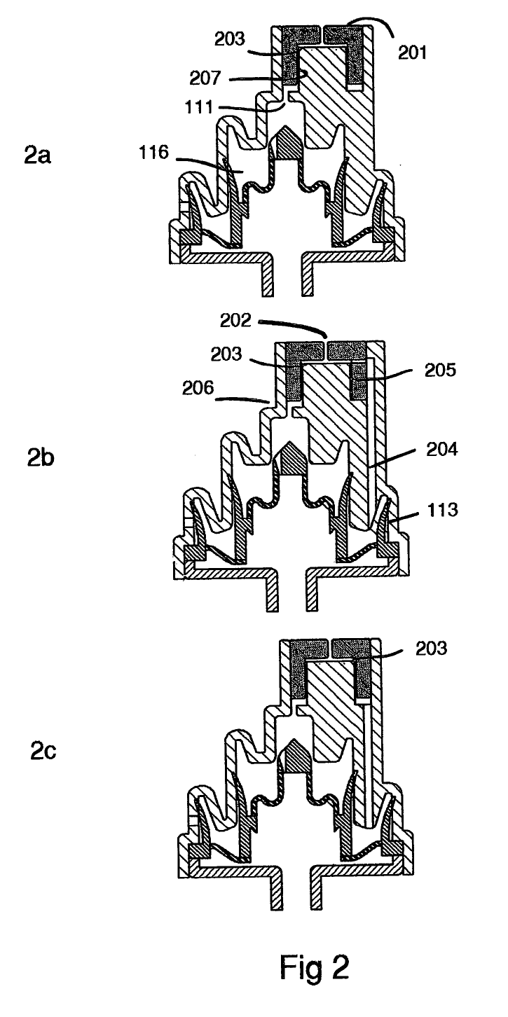

FIG. 2 is a cross-sectional view of a nozzle arrangement showing a preferred version where a second fluid is mixed with the first fluid with a swirl chamber and orifice and 3 different possible routes for the second fluid are shown.

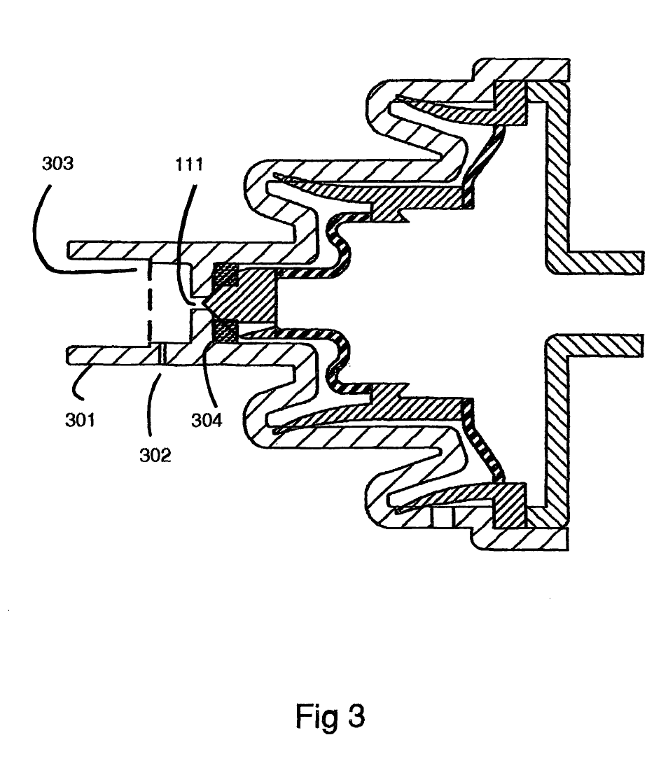

FIG. 3 is a cross-sectional view of a nozzle arrangement showing a preferred version where a second fluid is mixed with the first fluid for producing a foam with a mesh and a piece of foam in the nozzle body.

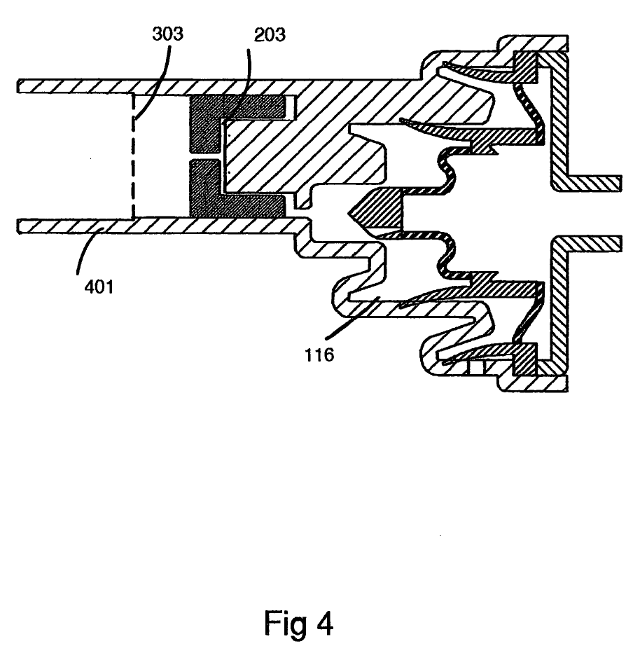

FIG. 4 is a cross-sectional view of a nozzle arrangement showing a preferred version where a second fluid is mixed with the first fluid for producing a foam with a mesh and a swirl chamber and orifice.

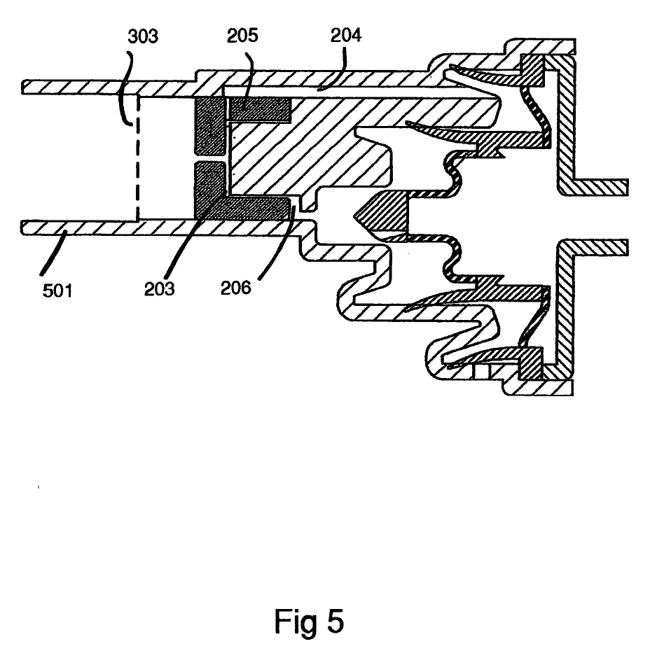

FIG. 5 is a cross-sectional view of a nozzle arrangement showing a preferred version where a second fluid is mixed with the first fluid for producing a foam with a mesh and a swirl chamber and orifice plus a separate second fluid outlet.

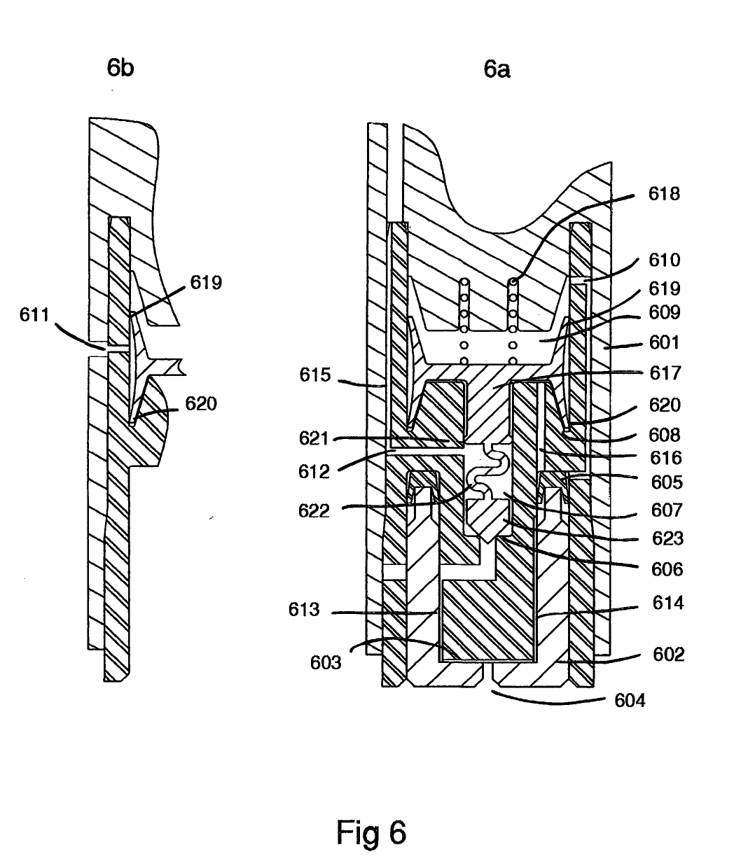

FIG. 6 is a cross-sectional view of a nozzle arrangement showing a preferred version where a second fluid is added to two pump chambers and then is mixed with the first fluid inside the nozzle and the pulsed element includes a main spring.

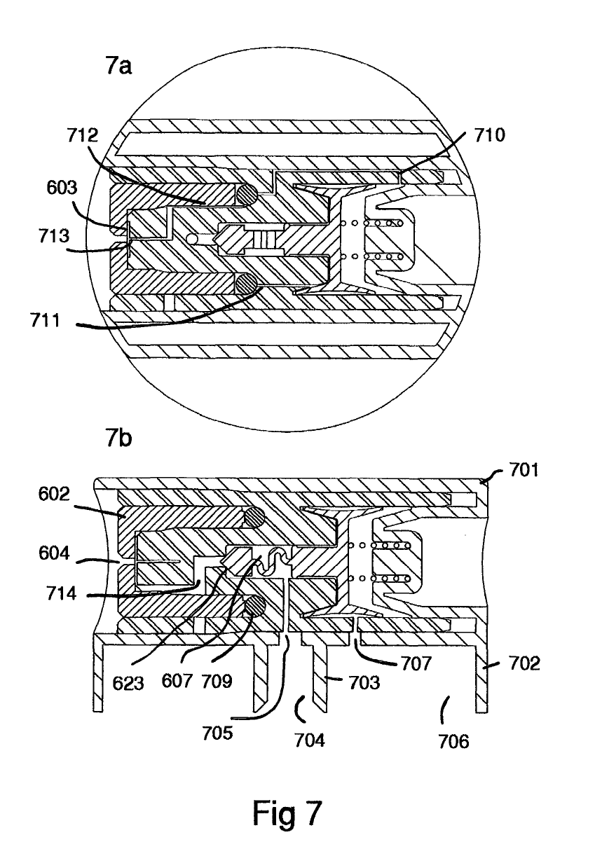

FIG. 7 is a cross-sectional view of a nozzle arrangement showing a preferred version as an aerosol actuator where a second fluid is added to two pumps chambers and then is mixed with the first fluid inside the nozzle.

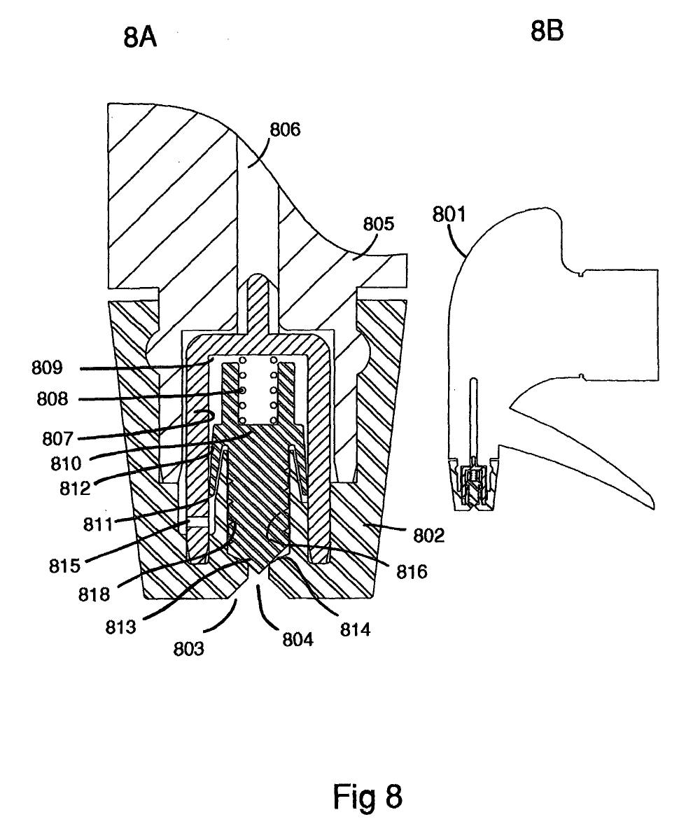

FIG. 8 is a cross-sectional view of a nozzle arrangement showing a preferred version where the nozzle is mounted onto the outlet of a trigger sprayer.

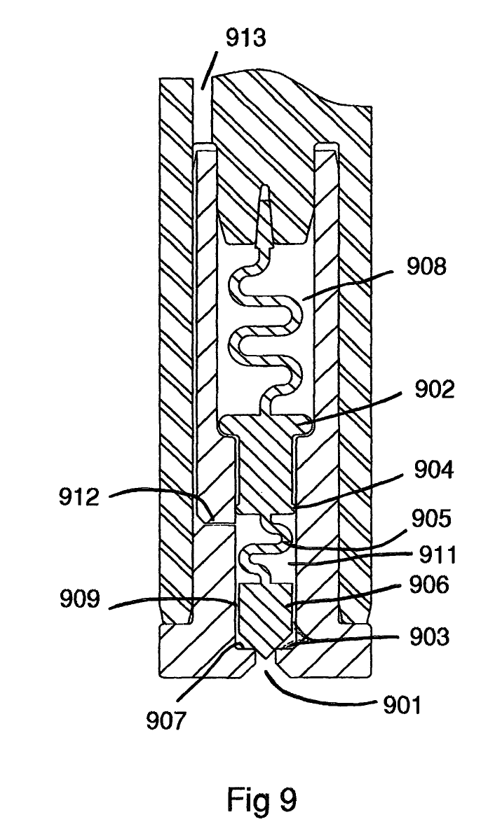

FIG. 9 is a cross-sectional view of a nozzle arrangement showing a preferred version where the pulsed element comprises one component and pumps one fluid through a spray orifice.

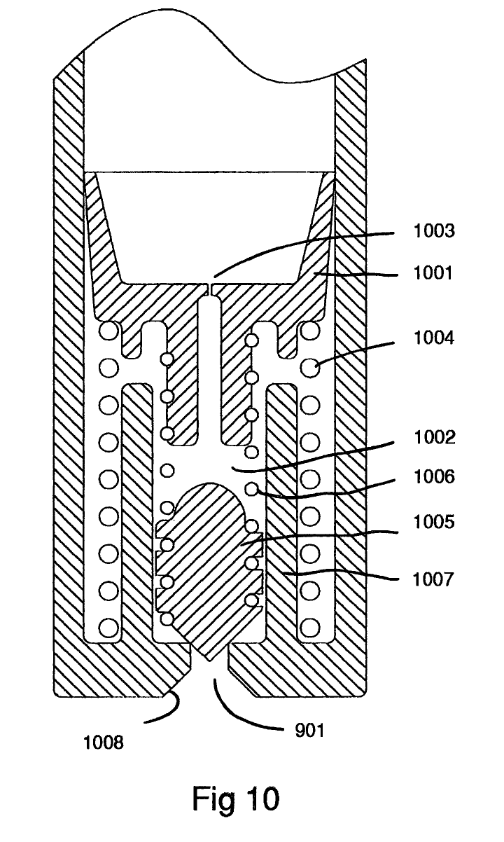

FIG. 10 is a cross-sectional view of a nozzle arrangement showing a preferred version where the pulsed element comprises two separate springs and pumps one fluid through a spray orifice and the main spring acts in an upstream direction.

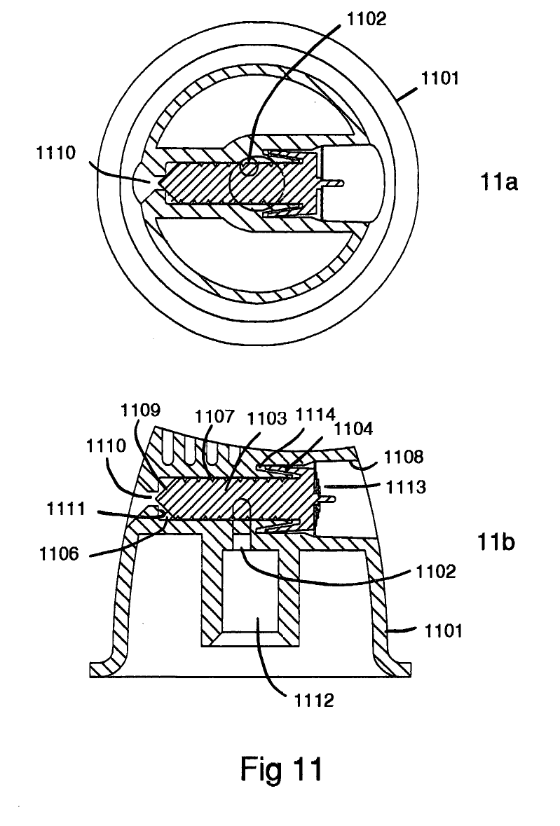

FIG. 11 is a cross-sectional view of a nozzle arrangement showing a preferred version where the nozzle arrangement is mounted in an aerosol actuator.

In FIG. 1 first, second and third we see an example of a nozzle arrangement showing 3 of the stages of operation. For convenience, we will refer to the part that causes the pulsed sprays as the pulsed element 114 throughout the text and claims. This can be made as one part or in several parts depending upon the application and we see a one part version in FIG. 1. The fluid enters into the base 102 of the actuator or nozzle body 101 through the inlet tube 103 which could be connected to an aerosol canister valve, to the outlet from a pump dispenser actuated by an actuator or a trigger, or a flexible tube or to any outlet from a pressurized fluid source such as the mains water or a showerhead or even a car engine. The body 101 is usually made in an injection moulded plastic such as polypropylene, polyethylene, nylon, polyurethane etc but could be made in other materials like metals as well and it is normally but not exclusively, substantially rigid. It could be extended in length so that it fits directly onto a device rather than using a base plate 102 which would also normally be substantially rigid and made of the same material as the body 101.

The pulsed element 114 is inside the nozzle body 101 and in a preferred version it is made in one part which is a moulded component made of a suitable resiliently deformable material such as a rubber or any suitable plastic including but not restricted to polypropylene, polyethylene, polyurethane, etc.

The upstream part of the pulsed element 114 has a resiliently deformable annular spring element 106 that also forms an annular seal 104, an annular sealing valve 105 and an inlet for the fluid entering the nozzle body 101 so it can go through the pulsed element. The downstream part of the pulsed element 114 has an annular sealing valve 107, an outlet for the fluid 109, a prodder or shaped part 110 for sealing the outlet hole 111 of the nozzle body 101 and a resiliently deformable spring element 108. The pulsed element 114 divides the nozzle body 101 into a number of different chambers with a main upstream chamber 112 and a main downstream chamber 116 and two secondary annular chambers with one being a small secondary upstream chamber 115 and the other being a secondary downstream chamber 113.

Fluid flows into the main upstream chamber 112 and pushes the pulsed element 114 downstream from its position as shown in FIG. 1 first into its position shown in FIG. 1 second. The main spring element 106 on the upstream end of the pulsed element 114 is tensioned as the pulsed element moves down until it meets the shoulder 117 of the nozzle body 101. Any fluid in the lower secondary chamber 113 is pumped past the one way downstream annular seal 105 into the main downstream chamber 116 with the first fluid.

The fluid in both secondary chambers is initially at ambient pressure. The prodder 110 seals the outlet hole 111 and the one way downstream annular seal 107 between the pulsed element 114 and the nozzle body 101 wall also seals any fluid in the downstream chamber 116. The fluid flows from the pulsed element 114 out into the main downstream chamber 116 through the leak hole 109. The fluid is pressurized and so it continues to flow into the main downstream chamber 116 until it is full and the pressure of the fluid acts upon the pulsed element 114 and moves the pulsed element 114 upstream because of the additional force of the main spring element 106. This action opens up the secondary downstream chamber 113 and the second fluid which is often air is drawn through the inlet hole 118 into the upstream secondary chamber 115 through the one way upstream annular seal 105 and into the secondary downstream chamber 113 and the fluid drawn in keeps the pressure in the secondary downstream chamber 113 at ambient pressure. As the pulsed element 114 moves upstream the spring element 108 of the prodder 110 expands and this process continues until the spring has reached its limit as shown in FIG. 1 third. At that point, the prodder 110 clears the outlet hole 111 and the prodder spring element 108 which is stretched as the pulsed element 114 moves upstream returns to its none tensioned position pulling the prodder 110 further away from the outlet hole. As soon as the prodder 110 clears the outlet hole 111, fluid starts to go through the outlet hole 111 and this causes a drop in pressure in the downstream main chamber 116 as the fluid in the upper chamber 112 cannot fill the lower main chamber 116 fast enough. Consequently, the pulsed element 114 moves back downstream forcing air out of the lower secondary chamber 113 past the annular valve 107 and into the downstream main chamber 116 where it mixes with the fluid and goes out of the outlet hole. The prodder 110 then reseals the outlet hole 111 and the pulsed element 114 continues to move down until it meets the shoulder 117 of the nozzle body 101. By then the main spring element 106 is tensioned again and the prodder spring element 108 isn't stretched. The lower main chamber 116 now contains some air and fluid mixed together and the air in the secondary downstream chamber 113 is substantially at ambient pressure. This process continues until the fluid in the nozzle is no longer pressurized and the pulsed element 114 moves upstream to the position shown in FIG. 1 first with both spring elements no longer tensioned. The fluid normally stays inside the nozzle arrangement because a shut off valve is usually upstream of the nozzle but if there isn't one; fluid could slowly drain from the nozzle through the pulsed element leak hole 109 and out of the outlet hole 111.

The speed of the pulsing is determined by the size of the leak hole 109, the pressure of the fluid, the strength of the main spring element 106, the size of the main downstream chamber 116 and the distance the spring element of the prodder 108 will allow the pulsed element 114 to move until the prodder 110 is pulled out of the hole 111. The discharge is determined by the size of the expanded main downstream chamber 116, the size of the secondary downstream air chamber 113 and the speed of return of the pulsed element 114, the pressure of the fluids. These things all have to be balanced to achieve the required performance.

The arrangement shown in FIG. 1 would normally produce a jet or bolus of fluid and often the outlet orifice would be followed by a swirl chamber and a further orifice and this would create an atomised spray. But there could also be a shaped orifice to produce a fan shaped spray or whatever is required. However, as will be explained in more detail later, if the leak hole 109 is angled so that it enters the final chamber around the tip of the prodder 110 tangentially then it will spin inside that chamber and out through the final orifice 111 creating an atomized spray. This would produce a hollow cone which is unacceptable for most applications but if the prodder movement is restricted so that some of the prodder tip always stays inside the final orifice 111 and the diameter and length of the orifice 111 plus the prodder tip angle and usually the downstream shape of the orifice 111 is optimized then a substantially full cone spray can be achieved. There can be more than one tangential outlet 109 from the prodder 110 as well to improve the spinning action and the quality of the spray. Even though the movement of the prodder 110 is then very small the plunger 114 can still be configured to have a relatively long movement so the ratio of fluids from the two chambers can be quite high or low as required.

In FIGS. 2a, 2b and 2c we see a swirl chamber 203 following the outlet orifice 111 and this produces an atomised spay. In FIG. 2a the 2 fluids are mixed in the downstream lower main chamber 116 and then go to a swirl chamber 203 and onto the spray orifice 202. In FIG. 2b the second fluid goes from the downstream secondary chamber 113 to a swirl chamber input 205 via the connecting channel 204. The first fluid also goes to the swirl chamber 203 input 205 and the 2 mix inside the swirl chamber 203. In FIG. 2C both fluids travel to the swirl chamber 203 and mix inside it.

If the swirl chamber and final orifice are followed by a tube 301 around the orifice 111 as shown in FIGS. 3, 4, 5 then a foam will be produced. This foam can be enhanced with 1 or 2 filter meshes 303 in the tube 301 and this arrangement is common practice. However, it can be further refined using a piece of open cell foam 304 in the downstream main chamber 116 and this is partially or totally squashed when the prodder 110 seals in the outlet hole 111. There may then be no, one or more meshes in the tube 303 according to the requirements of the foam produced and the fluid used. Air is usually used as the second fluid. In FIG. 3 we see a venturi air inlet 302 in the tube 301 and this is commonly used with foams to draw more air into the fluid and could be used on any of the foam variants.

FIG. 4 shows an arrangement that produces a foam using a mesh 303 following a swirl chamber 203 where the air and first fluid are mixed in the downstream main chamber 116. FIG. 5 is much the same except the air and fluid are mixed in the swirl chamber 203. Foam can also be produces with no tube and a mesh or with a tube and no mesh each with the possible fluid routes shown.

We have described the air or the second fluid as mixing in the downstream main chamber 116 or the swirl chamber 203 but it could mix in both and the second fluid will take the easiest route. So it depends upon how the valve 107 is configured and this could be made as a seal rather than a one way valve so air cannot get into the chamber 116. Or some fluid could go to the downstream main chamber 116 and some to the tube 301 upstream of the mesh 303. Like this it enhances the foam as it drives the fluid though the mesh. The second fluid could also go to one or more of the inputs to the swirl chamber 203 instead or as well as the chamber 116. Or it could go through the back of the swirl chamber 203 in the centre where the pressure is lower. Or it could join the fluid just before the swirl chamber 203. Or any combination of the above whether or not there is a tube following the orifice.

The ratio of the second fluid to the first fluid in the discharge is determined by the discharge per pulse and the volume of the second fluid in the downstream secondary chamber 113. Generally, the greater the size of the secondary downstream chamber 113 and the smaller the main downstream chamber 116 the higher the ratio.

Many applications mix 2 fluids to create a reaction between them and this system could easily do that. We have discussed fluid going into the second input and it could be any fluid including a liquor or gas or air and this could be drawn from any chamber or connecting tube and it wouldn't normally be pressurized although it could be. The second fluid could also be a mixture of a gas such as air and a liquor. The fluid or liquor could take any of the routes that the air took going to either the main downstream chamber, direct to the swirl input, or to the back of the swirl chamber, direct to a separate swirl chamber and orifice so two sprays join in the atmosphere, direct to an outlet tube or any other suitable alternative. Both the air and any fluid could also go to a tube that connects with the first fluid going through the downstream main chamber outlet into said tube. The second fluid could join the tube through a venturi hole to ensure that the fluids mix. In the examples shown, there is no one way valve in the outlet routes for the second fluid other than when it goes to the downstream main chamber but such a valve could be used if required.

The chamber 113 for the second fluid is shown as being larger than that of the first fluid but it would be simple enough to enlarge the downstream main chamber 116 and consequently reduce the secondary downstream chamber 113 enabling the discharges of the second fluid to be larger than those of the first fluid.

We have shown that the nozzle arrangement can be used in many applications and that it can deliver a pulsed discharge of 2 fluids into the atmosphere or into a device of some kind. For example, it could be used in an engine to deliver fuel and air combined. It could be used to add an additive into a main fluid stream in a process. It could mix 2 different fluids together where one is stored in say an aerosol canister and the other is stored at ambient pressure in a container outside or on top of the aerosol container. Or similarly, it could mix 2 different fluids together where one is stored in say a dispenser pump container and the other is stored at ambient pressure in a different container outside or on top of the first container. It offers a method of mixing 2 fluids together in any required ratio even when they are at different pressures initially. The 2 fluids can be mixed together in any suitable way either inside or outside of the nozzle arrangement.

The pulsing element has been shown as a one piece arrangement but it could be made in 2 or more parts and metal or plastic springs could be used instead of the resiliently deformable spring part of the pulsing element or instead of the resiliently deformable part of the prodder spring. Obviously, the simpler it is the cheaper it is to make and assemble.

Other designs of the pulsing element could be used and the important thing is to use a pulsing element that is able to move up and downstream so it can draw in a second fluid that is usually air and then pump that second fluid in such a way that it mixes or interacts with the first fluid.

The examples shown discharge two fluids substantially simultaneously but if one of those fluids is air then it can be advantageous to pump the air both when the pulsing elements moves downstream as shown and also or even instead, when it moves upstream so in effect when air is delivered with both strokes it delivers approximately twice the air with each cycle. The upstream stroke would only deliver air and not the first fluid but because the pulses are so fast that air could still be mixed with the first fluid both from the previous cycle and the next cycle. The air from the downstream stroke could be mixed with the first fluid either in the nozzle arrangement or outside of it as before. For example, if the device is set up to create foam then the air from the upstream stroke could help to clear away any residual foam reducing post foaming. This arrangement would usually be used with a liquor as the first fluid and air as the other fluid but it could be done with two different liquors and air as a third fluid.

FIGS. 6A and 6B show one such arrangement wherein there are three chambers with the downstream chamber 607 being the dosing chamber for the first fluid and there is a second chamber that is divided into two further air chambers with one chamber 609 being upstream of the main plunger 617 seal and the other chamber 608 being downstream of it. The first fluid enters the nozzle arrangement through the inlet channel 615 then to the channel 612 and then into the dosing chamber 607 between the prodder 623 and the downstream dosing chamber seal 621 of the main plunger 617. The prodder 623 seals the outlet hole 606 as normal and is connected to the main plunger 617 by a sprung element 622 so as the first fluid flows into the dosing chamber 607 it pushes the plunger 617 upstream expanding and stretching the prodder sprung element 622 and compressing the main spring 618. Simultaneously air is drawn in between the middle 620 and upstream 619 annular seals of the plunger 617 through the inlet hole 611 and into the expanding downstream air chamber 608 between the middle plunger seal 620 and the downstream wall of the chamber 608. Simultaneously, air is ejected from the contracting upstream air chamber 609 as the main plunger 617 moves towards the upstream wall of the chamber 609 and travels past the one way annular valve 605 though the channel 614 to the swirl chamber 603 and to the nozzle orifice 604. As the plunger 617 moves upstream so the main spring 618 is compressed and tensioned. The spring 618 may be any resiliently deformable element and could be part of the plunger 617 or separate to it as shown. The main plunger 617 draws closer to the upstream chamber wall until the expanding prodder spring 622 pulls the prodder 623 away from the outlet hole 606 allowing the first fluid to escape from the dosing chamber 607 and out of the spray orifice 604. The force of the compressed spring 618 then causes the main plunger 617 to move downstream until the prodder 623 reseals the outlet hole 606. Simultaneously air is drawn from between the two plunger seals 620 and 619 into the expanding upstream air chamber 609 and air is also pumped from the contracting downstream air chamber 608 through the hole 616 and past the one way valve 605 and to the swirl chamber 603 via the channel 614 where it mixes with the first liquor. The main plunger 617 then moves back upstream and closer to the upstream chamber wall and air is drawn from between the two plunger seals 620 and 619 into the expanding downstream air chamber 608 and air is also pumped from the contracting upstream air chamber 609 through the hole 610 and past the one way valve 605 and to the swirl chamber 603 via the channel 614. This process continues as long as the first fluid is delivered to the dosing chamber 607 at pressure.

If there was no prodder spring 622 then the main plunger 617 would only move a very short distance and a tiny amount of the first fluid would be expelled along with a tiny volume of air. But the pulses would be extremely fast so it is a possible configuration. Conversely, if the prodder spring 622 is very weak the plunger 617 would travel a long way so a big volume of liquor and air is delivered with each pulse but the pulses are much slower. If the prodder spring 622 is too weak then the plunger 617 would move until it fully compresses the main spring 618 and the prodder 623 would not have cleared the outlet hole 606 so nothing would be discharged. The ratio of the air to the first fluid also varies according to the distance the main plunger 617 moves because a very small movement doesn't pump the air as efficiently as a longer movement so getting the balance right is very important. The prodder spring 622 is set so that the required movement of the main plunger 617 is achieved and the pulse rate is as fast as possible plus a required air to fluid ratio is achieved. The ratio of air to liquor discharged is primarily dependant on the ratio of the plunger 621 diameter in the dose chamber 607 to the plunger 617 seal diameter in the air chamber. Sometimes it is preferable to have a high air to fluid ratio so the air plunger seal diameter tends to be larger than the dose chamber plunger 621 diameter and something like a ratio of up to 6/1 is preferable but any practical ratio can be used and we aren't restricting the claims to that range. Sometimes a ratio of as low as 0.5/1 is preferable as that means the fluid pressure can be higher.

The main restriction to having a high ratio of fluid from the upstream chamber or chambers compared to the dose chamber 607 is that the pressure in those chambers is proportional to the ratio so if the chambers are twice the size of the dose chamber 607 in total then the pressure is less than half of the pressure in the dose chamber 607. There can be problems mixing the 2 fluids if there is a big pressure difference between them as well. This means that in practice for most applications the size of the upstream chambers relative to the dose chamber 607 is usually limited to less than 6/1 and often less than 2/1.

The strength of the main spring 618 is also very important and this is very dependant on the pressure of the first fluid which has to be higher than the pressure generated by the main spring 618 to move the plunger 617 upstream. If the main spring 618 is very weak then it won't be able to push the main plunger 617 back downstream and if it is too strong then the main plunger 617 if it can move at all will move upstream too slowly. So the balance has to be correct for it to pulse especially at the speed required. Yet another factor is the size of the outlet hole 606 compared to the inlet hole 612 because if the ratio isn't sufficient the device won't pulse at the required rate or even at all. If the inlet hole 612 is larger than the outlet hole 606 then the prodder 623 will come away from the hole 606 and stay away so there is no pulsing and just a continuous flow. If the final spray orifice 604 is smaller than the outlet hole 606 then that controls the pulsing instead of the outlet hole 606 but if the spray orifice 604 is larger than the outlet hole 606 then the outlet hole 606 controls the pulse rate.

So it is very difficult balancing up the system and especially with pumping air in both parts of the cycle.

In many applications atomized sprays are created using swirls where fluid enters a cylindrical chamber tangentially through the side walls of the chamber and spins in the chamber before exiting a spray orifice in the centre of the downstream face of the chamber. Sometime air or gas is mixed in or upstream or even downstream of the chamber to enhance the spray quality. We have often considered the prodder outlet being followed by a swirl to create a spray but the prodder itself in the outlet hole can be configured to create an atomised spray. The prodder outlet hole can then become the final spray orifice or it could be followed by another chamber. The prodder tends to only move a short distance and that can be configured to be as short as required. The first fluid can then be made to spin around the prodder or just after the prodder as it exits the prodder outlet and this causes the fluid to produce an atomized spray. The prodder and outlet hole would be shaped to enhance this spray which would be pulsed. When the nozzle device isn't operational, the prodder would seal off the outlet hole and swirl arrangement and this can be a big advantage with some products such as food products where the product can be adversely affected by prolonged exposure to the air. Pulsing the spray also means that small volumes of the fluid are manipulated rather than a stream of fluid and this can offer more opportunities for optimising the spray.

With industrial spray applications there are many ways of manipulating the sprays and usually they involve air which is either mixed with the fluid in high ratios of air to the fluid or used to create a shock wave to break up the droplets. With compressed gas aerosols or pumps or triggers there is hardly any or no air available so there is only the possibility of using swirls to atomize the sprays. These haven't really changed much in over 50 years and they are very limited in what they can achieve. Using the pulsed element in the orifice offers the opportunity of using an engine or tool to manipulate the sprays in ways that haven't been possible before. It can be used as has been shown in the previous diagrams where air is added at various stages but it can also be used effectively without air.

In FIGS. 7a and 7b we see a plan elevation and a side elevation of an aerosol cap 701 that uses a very similar configuration to that shown in FIG. 6.

The actuator is fixed onto an aerosol can inside of the circumferential outer wall 702 occupying some of the space 706. The aerosol valve is held in the tubular recess 704 formed by the circumferential wall 703 and a seal is formed between the two. When the actuator 701 is depressed the aerosol valve is moved down and opens allowing the pressurized fluid to flow to the dosing chamber 607 via the channel 705. Air is drawn from the space 706 underneath the actuator 701 and is pumped through the hole 707 to the channels 710 or 711 through an 0 ring one way valve 709 to the channel 712 and through a hole 713 in the back centre of the swirl chamber 603 and then is sprayed out of the orifice 604. It operates fundamentally the same as described in FIG. 6. This is just another example of how the technology can be configured to pump air as well as a fluid from the aerosol can. The air could travel to any position in the swirl 603, any suitable one way valve could be used instead of the 0 ring valve 709, a different type of spray nozzle to 602 could be used with the air and fluid being mixed in a number of different ways.

In FIGS. 8A and 8B we see a simpler version of the pulse element where there is no second fluid and where the prodder outlet hole 804 is the spray orifice. The nozzle arrangement is shown mounted onto the outlet of a trigger activated manually operated dispenser but could just as easily have been mounted on a dispenser activated by an actuator or it could be mounted on or in any device where pressurized fluid is delivered and usually as an atomized spray. The nozzle 802 is fixed to the outlet 805 of the trigger sprayer and comprises a conically tapered outlet 803 and a substantially straight exit hole 804. A cover part 807 is fixed into the nozzle 802 and pushed inside the trigger sprayer outlet 806. The trigger outlet 806, the nozzle 802 and the cover part 807 are all sealably connected so that the fluid can only escape through the outlet orifice 804. The plunger and prodder are made in one 810 and have a circumferential seal 811 that seals between the prodder 810 and the cover part 807. A spring 808 that is around the upstream end of the prodder 810 and inside of the cover part 807 pushes the prodder 810 downstream causing the prodder tip to seal the outlet orifice 804 in the rest position.

As the trigger handle is pulled fluid is pumped through the channel 806 and around the cover part 807 through the hole 815 in the cover part 807 and into the chamber 817 around the prodder 810. The fluid cannot flow upstream inside the cover part 807 because of the seal 811 so it flows around the prodder 810 towards the outlet orifice 804. The prodder 810 sits inside a tubular section 818 of the nozzle 802 and there are threads 816 around the prodder 810 that cause the fluid to flow around the prodder 810 and to spin around the conically tapered part 813 of the prodder. Preferably there are 3 threads around the prodder 810 with 3 entry and exit points so the fluid spins evenly around the prodder 810. Once the pressure of the fluid around the prodder 810 has increased enough to overcome the force of the spring 808 which is pretensioned to a set force so the prodder 810 moves upstream unsealing the outlet orifice 804 and allowing the fluid to be discharged. The distance the prodder 810 moves upstream is determined by the strength of the spring 808, the pressure of the fluid, and the distance between the seal 811 and the shoulder 809 on the cover part 807 which is designed to act as a back stop. The distance is also determined by the size of the orifice 804 since if it is very large then even a small upstream movement of the prodder 810 will result in a large gap and the prodder 810 may not move that far. As soon as the prodder 810 has unsealed the outlet orifice 804 the fluid will discharge and the flow will increase as the prodder 810 moves further away. Then as the pressure reduces so the prodder 810 will move back upstream under pressure from the spring until it finally reseals the outlet orifice 804.

To make this arrangement pulse the prodder 810 has to be made resiliently deformable either by just the material or by shaping the prodder 810 itself and an example of this. So, when the prodder 810 first moves upstream the prodder 810 stretches or reforms and the prodder 810 stays sealed in the outlet orifice 804 until it is easier for the prodder 810 to move into an unsealing position rather than stretch or reform anymore. So the prodder 810 acts as a spring and a more obvious example is shown in FIG. 3 where an integral shaped spring 305 is created. Once it reaches an unsealed position the fluid will quickly discharge and provided the discharge is faster than the fluid can enter into the chamber 817, the prodder 810 will return to the sealed position. This process continues until most of the fluid is discharged and produces a pulsed spray.

If the prodder tip 813 moves completely out of the outlet orifice 804 then a substantially hollow cone with large droplets is produced and this is not desirable. But if the prodder tip 813 is always kept partially inside the outlet orifice 804 so there is always a circumferential gap between the prodder tip 813 and orifice 804 then a spray with fine droplets can be produced. Even then the spray produced is substantially a hollow cone which is still not desirable. This problem can be reduced by shaping the outlet orifice upstream wall 814 such as making it conical as shown as this effectively extends the length of the outlet orifice 804 enabling the prodder 810 to move further upstream. It also impacts on the angle and form of the final spray. But as shown in FIG. 9 and other figures this wall could also be perpendicular to the chamber and that will be better for some nozzle arrangements used on triggers. But the diameter, length and angle of the prodder tip 813, the diameter and length of the outlet orifice 804, the circumferential gap, the position of the prodder tip 813 in the orifice 804, the shape of the outlet orifice upstream wall 814 and the shape of the outlet orifice 803 can be optimized in such a way that a substantially full cone with fine droplets can be produced. This arrangement is so important that we have split it off into a sister patent that is being released simultaneously with this that focuses on the spray technology itself. It is important both for a pulsed spray and as a continuous spray. More will follow about this.

As the prodder 810 moves upstream the air inside the cover part 807 that is upstream of the seal 811 is compressed and then returns to ambient pressure as the prodder returns to the sealing position. Since the movement is so small the change in air pressure isn't great so it isn't a problem. But it would be easy enough to design in an air release valve system in that chamber if it was a problem.

This nozzle arrangement has been configured to retrofit to current triggers but if the main body part of the tool is altered then the cover part 807 can be designed out reducing the overall cost. But it is often cheaper and simpler for a company to make the nozzle arrangement off line and then add it onto the current triggers. Any of the different configurations shown could be fitted to the trigger sprayer instead.

The nozzle arrangement could easily be adapted to fit any device that delivers a pressurized fluid.

In FIG. 9 we see another simpler version of the nozzle arrangement where there is no air generated and with no swirl chamber or extra spray orifice. It is very like the one shown in FIG. 8 but there is an integral main spring 908 and there is a prodder spring 905. The fluid is sent under pressure through the channel 912 tangentially into the dosing chamber 911 between the prodder 906 and plunger seal 904 as before but there is no second fluid or air or a second pump chamber. The tangential input 912 causes the fluid to spin in the chamber 911 and around the prodder 906 as it exits as an atomised spray.

Normally but not necessarily, there is a sprung element 905 between the prodder 906 and plunger 902 as before so the plunger 902 moves upstream as the chamber 911 fills until the prodder spring 905 is tensioned and pulls out the prodder 906 and the fluid in the chamber 911 is discharged as the main spring 908 pushes the plunger 902 downstream until the prodder 906 reseals in the outlet hole 901. The main spring 903 and the prodder spring 905 may be integral to the plunger 902 or separate parts as required. Often, the pulsing element would be one part for cost and size and this is then exceptionally cheap which is ideal for aerosols, pumps and triggers.

What is different between this and any ordinary pulsed nozzle arrangement is that like in FIG. 8 the pulsed element is being used to generate and manipulate an atomised spray with movement of a component in the spray orifice. In this case the movement is by the prodder 906 of the actual pulsing element but it could instead be a different part to the pulsing element and be moved by the pulsing action. It is also possible to follow the outlet 901 and prodder 906 combination with a second spinning arrangement that takes the atomised spray from the prodder orifice and further refines the spray.

It offers an amazing number of possibilities for manipulating the spray. As already mentioned the fluid can spin around the prodder 906 as it enters into the outlet orifice 901. The prodder tip 906 can extend partially or wholly into that orifice 901 so it can either spin around the prodder 906 as it travels all the way through the orifice 901 or for part of the way through and then continue spinning in the remainder of the orifice 901. The spinning action can be generated by appropriately shaped grooves in the prodder 906 as seen in FIG. 11, orifice 901, and wall 903 of the dose chamber 911 or any combination of them. Or it could be generated by suitably shaped fins around the prodder 906 body and between the prodder 906 and dosing chamber wall 903. Or the fluid could be directed so it enters the chamber 911 tangentially so it spins around the prodder which could then be smooth with no grooves or threads. The outlet orifice 901 can be shaped in any suitable way to enhance the manipulation of the spray.

Normally, the pulses will be short strokes with the none air versions so that they are fast. Air or gas could be added to the fluid itself such as in an aerosol canister for example with butane or CO2 as the propellant where some gas naturally exists in solution creating bubbles and extra could be added through a bleed hole in the valve called a vapour phase tap. So even compressed air or nitrogen could be used. It is this movement of the prodder 906 that offers so many new ways of manipulating the spray. With each pulse, the prodder 906 hits the orifice wall 907 and this can be used to set up a shock wave that further breaks up the droplets in the spray. This could be achieved by shaping the outlet 901 and adding a shaped chamber downstream of it. Similarly, a sound wave could be generated for the same purpose and generated by the prodder 906 striking the orifice wall 907. Or a component could be added downstream of the prodder 906 that is connected to it or just struck by it with each pulse and this could be made to vibrate by the prodder 906 movement and that vibration could cause a shock or sound wave to break up the droplets further. Or the spray could strike the vibrating part to cause or enhance atomisation. An open and shaped chamber could follow the orifice 901 to enhance these innovations.

With swirls, the smaller the orifice hole the finer the droplets but you can only mould hole sizes above a certain size in mass volumes because of the pins in the tools that make the holes breaking. Typically the limit is around 0.18 mm diameter. With a prodder in the orifice the hole becomes the circumferential gap between the prodder and orifice. The size of the circumferential gap between the prodder and orifice is determined by the flow required with the lower the flow the smaller the gap but normally the gap is the equivalent of hole sizes that vary from 0.05-1 mm diameter and more usually 0.15-0.6 mm diameter. The orifice diameter used is normally but not exclusively between 0.3-2 mm and more usually 0.5-1.5 mm with the prodder diameter being very close to that of the orifice. So the circumferential gap 103 can be 0.3 mm down to as small as 0.005 mm and often smaller than 0.08 mm. With fixed prodders it can be difficult to make such a small circumferential gap but when the annular gap is created by the movement of the pulse and that movement can be made very small then so a very small annular gap is generated and this can be made to create a hollow cone spray that produces fine droplets. By shaping the orifice or a chamber afterwards the hollow cone can be converted into a full cone again with fine droplets. The fluid is spun through the annular gap to create the atomization.

The prodder 906 can be shaped so that it rubs against the wall 903 of the dosing chamber 911 and by making the wall 903 of the inserted part and prodder 906 in the appropriate materials an electrostatic charge can be generated between the two parts so the fluid being discharged picks up the charge as it is sprayed charging the spray. This inserted part also extends upstream of the plunger seal 904 and that also increases the charge generated when the seal 904 rubs against it. Having two parts rubbing against each other at the orifice and generating a pulsed spray is an ideal combination for generating an electrostatically charged spray. This would work with the air and none air versions and with the prodder 906 followed by a swirl and orifice or with the prodder in the orifice as described. When a swirl is used, the prodder 906 could rub against the part containing the post of the swirl instead of the orifice wall. Suitable materials that could be used in the parts to facilitate the electrostatic charge of the fluid would include materials such as a rubber like edpm or viton and a material like nylon or polyurethane where they are placed towards the ends of the Triboelectric Series is a list of materials. These readily give up their charge. The point of all of these examples is that the movement of the prodder in the spray orifice either directly or indirectly can be designed to be an active part of the spray manipulation. There will be other ideas than can be used with this pulsing element and these will doubtless be developed over time.

The way that the prodder 906 and orifice 901 can enhance the spray can also be used in conjunction with the air generated by the air plunger as described in some of the previous examples. The air could be directed into the orifice itself and part of the way downstream of it and downstream of where the prodder would seal in the orifice. Or it could be directed at the spray as it leaves the orifice. Or it could be added to a chamber after the orifice such as where the spray is directed tangentially into a cylindrical chamber so it spins in the chamber and the air also usually spins and often counter tangentially. The fluid combination then exits through an end of the chamber. The air could also be added in such a way that it creates a shock wave that impacts on the spray further manipulating the droplets. Plus as previously stated, air or gas could also exist in the fluid.

In FIG. 10 we see a similar configuration to FIG. 1 but using separate springs and no second fluid. The fluid passes through the plunger 1001 into the dosing chamber 1002 through the hole 1003 and the plunger spring 1004 pushes the plunger 1001 upstream. This means that in the rest or off position, the prodder 1005 is away from the outlet hole 901 in a none sealing position and the plunger 1001 is further upstream. In use, the fluid acts on the plunger 1001 and pushes it downstream compressing the plunger spring 1004 until the prodder 1005 seals the outlet hole 901 and then compresses both springs 1004, 1006 until the plunger 1001 reaches its maximum downstream position. The fluid passes through the leak hole 1003 in the plunger 1001 and fills up the dosing chamber 1002 which causes the plunger 1001 to moves upstream and the prodder spring 1006 to stretch. This process continues until the prodder spring 1006 becomes tensioned enough to overcome the pressure of the fluid acting on the prodder 1005 and the prodder 1005 is pulled out of the outlet hole 901 allowing fluid to escape through the outlet hole 901. Once the prodder 1005 is clear of the outlet hole 901 the prodder spring 1006 returns to its none tensioned position further pulling the prodder 1005 away from the outlet hole 901. But because the fluid is escaping through the outlet hole 901 the plunger 1001 is also moving downstream pushing the prodder 1005 towards the outlet hole until it seals there. Varying the leak rate through the inlet hole 1003 in the plunger 1001 determines the speed of the cycles as does the strength of the two springs and a pulse rate of anywhere from very slow to very fast to a continuous flow can be achieved. The stronger the prodder spring 1006 the less distance the plunger 1001 moves and the lower the dose per cycle and vice versa. It can also be configured so that the flow is continuous instead of pulsing and the prodder 1005 can be made to move only a short distance away from the sealing position. This is mostly achieved by ensuring that the flow into the dose chamber 1002 is higher than the flow out so the prodder 1005 cannot return to the sealing position. By causing the fluid to rotate around prodder 1005 usually with circumferential grooves either in or around the prodder 1005 or around the chamber wall 1007, an atomised spray can be produced from the orifice 901. These grooves can also hold the prodder spring 1006 as shown as there is still enough space for the fluid to flow in the grooves. But to achieve a fine and even spray the prodder 1005 cannot come too far away and ideally it is very close to the sealing position so that a tiny circumferential gap is formed between it and the prodder 1005 in the orifice 901. Also the orifice 901 preferentially but not exclusively has an outwardly tapered cone 1008 at the downstream end. If the prodder 1005 angle and length inside the orifice and pointed tip, the gap between the prodder 1005 and the orifice, the straight tubular section of the nozzle orifice in length and diameter, the angle and length of the outlet cone, the spinning action of the fluid around the prodder 1005, the distance the prodder 1005 moves aren't fully optimized the spray is very poor with large droplets and a hollow cone spray shape but if everything is fully optimized the spray is exceptionally good with fine, substantially evenly sized droplets and a full, even cone shape.

In FIGS. 11 a and 11b we see a version of FIG. 8 used in an aerosol can actuator 1101. 11 a shows the prodder 1103 in the rest or sealed position and FIG. 11b shows the prodder 1103 in the spraying position with a small circumferential gap around the prodder 1103. It is much simpler though because the actuator inlet 1102 from the tubular chamber 1112 where the aerosol valve is sealably fixed, is easily configured to enter tangentially around the prodder 1103 downstream of the prodder seal 1104 where it flows both upstream to the small downstream chamber 1106 around the tip 1109 of the prodder 1103 and then to the final orifice 1110 and simultaneously downstream to the plunger seal 1104 which prevents the fluid from escaping upstream by sealing on the chamber wall 1114. There is a spring 1113 upstream of the prodder 1103 that is fixed in place and retains the prodder 1103 inside the chamber 1114 and this exerts a downstream force on the prodder 1103 so that it stays in the sealed position when at rest. The spring 1113 is usually but not exclusively pretensioned to something like 1 bar upwards so that force has to be overcome before the prodder 1103 moves away from the sealed position. With aerosols the flows tend to be very small and usually under 3 mls/sec so there is very little movement of the prodder 1103 before the spring 1113 also acts as a back stop preventing further upstream movement. This ensures that the prodder tip 1109 never leaves the final orifice 1110. There are 1-3 circumferential threads around the prodder 1103 so the fluid spins around the prodder 1103 until it reaches the tiny chamber 1106 when it spins around the prodder tip 1109 and then exits the orifice 1110 as an atomized spray. The design has to be optimized as described earlier to ensure that a substantially full cone is produced. The prodder 1103 could have no grooves and instead a circumferential gap between it and the chamber and as the fluid enters tangentially from the inlet it will still spin around the prodder 1103 and out into the tiny chamber 1106. As in FIG. 8 the basic configuration won't produce a pulsed spray but will produce a continuous spray and to make the spray pulse it is necessary to make the prodder 1103 resiliently deformable or to shape it such as in FIG. 9 so it can deform and reform like a spring. That way the prodder 1103 stretches upstream before the prodder tip 1109 moves to an unsealed position allowing the fluid to discharge which allows the prodder 1103 to return to the sealed position driven by the main spring 1113 reforming.

A back stop can be added to many of these configurations so that the prodder can only move a set distance away from the sealing position. The springs can often be configured to ensure that the prodder movement is minimal. If there isn't one then the prodder tends to move further downstream creating a larger circumferential gap and this produces larger droplets. Also, the further the prodder moves the harder it is to configure everything so that a full cone with fine droplets is always produced. For applications where you want the nozzle arrangement to clean itself then you want a big movement to be possible yet this would create large droplets and a hollow cone so one option is to make the back stop so it can be moved or even taken away for the self cleaning cycle. There are many ways to achieve this including something as simple as a peg that can be temporarily removed or even a back stop that can be screwed or slid into position. Similarly the spring could be varied in tension instead.

The key to the configurations with the prodder in the orifice is that the prodder is able to move to find its own position in the orifice which is very dependant on the flow and also it preferentially but not exclusively needs to be substantially close to the sealing position in the normal operating position. As has been stated, everything has to be optimized for this to produce even a reasonable atomised spray let alone a high quality spray. Some of the versions are pulsed and can generate air as shown in previous figures and others produce a continuous discharge and cannot generate air, shock waves or an electrostatic charge. Many of them can be configured to act as a precompression valve where the nozzle arrangement won't open until a set pressure has been reached and many can also be configured to act as a self cleaning nozzle. Some of the versions also seal the orifice after use which can be very useful for some fluids.

One of the most advantageous properties of all of the configurations where the prodder is in the outlet hole and a small circumferential gap is used to create a spray or foam is where gas or air is added to the fluid. Normally you need to add a lot of gas to have any real effect on the spray but because the gaps are so tiny, far less gas is needed to create the same improvements. So for generating finer droplets or for atomizing viscose fluids or for creating foams much less gas is needed. This gas can be added to the liquor itself in the canister or anywhere between the canister and the final orifice or in or downstream of the final orifice. Even ratios as little as 1/2 gas to liquor make a big difference whereas normally you need a minimum of 7/1 and usually much higher.

One of the problems with some of these configurations is moving the prodder far enough upstream to create a full circumferential gap around it because the liquor tends to move it only as far as is necessary and it means that at low flows a full cone isn't produced. Having gas or air in the fluid effectively increases the flow since the liquor flow rate is the same and this means that the prodder has to move further upstream and a full cone is produced at much lower liquor flows. It is generally better controlling the flow with a prethrottle and the prodder will move far enough upstream to maintain the flow set by the prethrottle. Preferably but not exclusively the prethrottle is positioned just upstream of the dose chamber holding the prodder and also preferentially the prethrottle directs the fluid into said chamber substantially tangentially causing the fluid to spin around the prodder. The prethrottle can also have a flow controller on or upstream of it so the fluid flow is maintained within set limits independent of the pressure of the fluid as this maintains a more constant circumferential gap around the prodder.

The orifice has been shown to have an outwardly tapered cone to produce a full cone spray. But this could also be shaped as an outwardly tapered oval cone to produce a fan shaped or oval spray. Or it could be shaped as a square tapered cone to produce square cones. Usually the fluid would still be made to spin before the final orifice but not always.

It is also possible to have 2 circumferential gaps in series in the orifice and even to add air in between them and preferentially tangentially to aid the spinning of the fluid. So the spray that is produced from the upstream circumferential gap and between the two circumferential gaps is then forced to break up further from the action of the downstream circumferential gap forming an atomized spray with finer droplets.

There appears to be a big difference between some of the designs shown but they are fundamentally the same. They rely on using a dose chamber with an inlet that is usually tangential and controls the flow of fluid into it, an outlet from the chamber, a prodder and plunger in the chamber that may or may not be integral and have a sprung element between them and the prodder enters the outlet office from the chamber, the plunger is sprung loaded at the upstream end and seals off the chamber upstream, the prodder pulses quickly and generates an atomized spray which is sometimes converted into a foam. In all of the versions the plunger actually moves air upstream of it in the chamber but only some of the versions make use of that property with some pumping air to affect the discharge and others using liquor, gas, air or a combination of them. Some versions use a standard swirl and others use the fluid spinning in the dose chamber around the prodder in the orifice as a swirl but they all produce an atomized spray. Some start with the prodder clear of the orifice in the rest position and these are best for making them self cleaning whilst others start with the prodder sealed in the orifice but all versions use the prodder in the orifice at some point. Even those that create a charge operate in the same way but make sue of the appropriate materials to create the charge.

In most cases when pulsing a very fast pulsed spray is required so it appears to be a continuous spray. This is usually in excess of 20 pulses per second and certainly over 10. However, it has been shown that these arrangements can also produce a continuous spray and where the prodder stays in the orifice this can be configured to make an excellent atomized spray and this makes a very valuable set of products.

Whereas the invention has been described in relation to what is presently considered to be the most practical and preferred embodiments, it is to be understood that the invention is not limited to the disclosed arrangements but rather is intended to cover various modifications and equivalent constructions included within the spirit and scope of the invention.

1. A nozzle arrangement connected to a source of pressurized fluid that produces a series of fast pulsed discharges of fluid in quick succession wherein the nozzle arrangement comprises a nozzle body with an inlet for the pressurized fluid into a chamber with a downstream wall with an outlet hole in said chamber wall wherein a prodder moves between a sealed and unsealed position in said outlet hole of the chamber wall and wherein a sprung plunger that is upstream of and connected to said prodder and has a annular seal that forms a seal between said plunger and the chamber creating a mobile chamber wall upstream of the downstream wall in said chamber, simultaneously moves between a downstream and an upstream position as the chamber fills with the fluid and then returns to a downstream position as the prodder returns from an unsealed position to a sealed position while the fluid is discharged.

2. A nozzle arrangement according to claim 1 wherein the prodder and plunger are one component, and/or wherein the prodder and plunger are integral and resiliently deformably connected.

3. (canceled)

4. A nozzle arrangement according to claim 1 wherein the plunger also acts as a plunger in a second chamber in the nozzle body for a second fluid and draws in and pumps that second fluid out of the second chamber with each pulse cycle, optionally wherein the plunger also acts as a plunger in a third chamber in the nozzle body and draws in air and pumps that air out of said third chamber with each pulse cycle.

5-7. (canceled)

8. A nozzle arrangement according to claim 1 wherein the fluids are mixed in a chamber inside of the nozzle body as they are discharged, or wherein the fluids are mixed in a chamber outside of the nozzle body as they are discharged.

9. (canceled)

10. A nozzle arrangement according to claim 1 wherein there is an outlet tubular chamber downstream of the outlet hole that is arranged to cause the spray discharge to foam, optionally wherein there are one or more meshes in said tubular chamber.

11-13. (canceled)

14. A nozzle arrangement according to claim 1 wherein the nozzle arrangement is connected to the outlet of any pressurized container or aerosol canister, optionally wherein the nozzle arrangement is used to generate a pulsed spray or foam from the pressurized container or aerosol canister.

15. A nozzle arrangement according to claim 1 wherein the nozzle arrangement is connected to the outlet of a manually activated dispenser pump that is actuated by an actuator or a trigger and produces more than 3 pulsed discharges of fluid for every actuation of the pump dispenser, optionally wherein the nozzle arrangement is used to generate a pulsed spray or foam from the pump.

16. A nozzle arrangement according to claim 1 wherein at least one of the following applies:
(i) the nozzle arrangement produces more than 3, 10, or 20 pulsed discharges of fluid every second;
(ii) the outlet hole of the chamber is the final spray orifice;
(iii) the prodder seals the final spray orifice in its rest position.

17-18. (canceled)

19. A nozzle arrangement according to claim 1 wherein the prodder is clear of the final spray orifice in its rest position, optionally wherein the prodder or plunger moves to a self cleaning position in the rest position.

20. (canceled)

21. A nozzle arrangement according to claim 1 wherein the position that the plunger can move to can be varied by the user, and/or wherein the maximum upstream travel of the plunger is restricted.

22. (canceled)

23. A nozzle arrangement according to claim 1 wherein during at least some of the discharge at least part of the tip of the prodder extends into the spray orifice to atomize the spray through at least one circumferential gap between the prodder and orifice, optionally wherein at least one circumferential gap is less than 10, 20, 100 or 500 microns.

24. A nozzle arrangement according to claim 1 wherein during substantially all of the discharge at least part of the tip of the prodder extends into the spray orifice to atomize the spray through at least one circumferential gap between the prodder and orifice.

25. (canceled)

26. A nozzle arrangement according to claim 1 wherein one or any combination of the orifice, plunger, prodder or chamber wall are shaped or have indents or grooves so as to cause the fluid to rotate around at least part of the prodder tip upstream of the circumferential gap to atomise the spray, and/or wherein the fluid inlet into the chamber is substantially tangential to cause the fluid to spin around the prodder and wherein at least part of the prodder is substantially smooth.

27-28. (canceled)

29. A nozzle arrangement according to claim 1 wherein there is a throttle upstream of the prodder that contributes to the flow control.

30-31. (canceled)

32. A nozzle arrangement according to claim 1 wherein an electrostatic charge is generated between the prodder and dosing chamber walls by shaping one or both parts so that they rub against each other during the pulses and they are both made of suitable materials to enhance that charge and wherein the fluid being discharged picks up that charge to generate a charged spray or foam, optionally wherein the plunger and seal also rub against the chamber wall or inserted part to increase the electrostatic charge in the discharged fluid, optionally wherein suitable materials that could be used in the parts to facilitate the electrostatic charge of the fluid would include materials such as a rubber including edpm or viton and materials including nylon or polyurethane where they are placed towards the ends of the Triboelectric Series in a list of materials.

33-35. (canceled)

36. A nozzle arrangement according to claim 1 wherein the prodder remains in the sealing position until a set fluid pressure has been reached.

37. (canceled)

38. A nozzle arrangement according to claim 1 used to generate a pulsed spray or foam from a pressurized fluid source including an aerosol canister where a second fluid or air is also drawn in and pumped out with each pulse.

39. (canceled)

40. A nozzle arrangement used to generate a pulsed spray or foam from a pump including one actuated with an actuator or trigger handle wherein there are at least 3 pulses per pump cycle and wherein a second fluid or air is also drawn in and pumped out with each pulse.
